(19) United States
(12) Patent Application Publication
(10) Pub. No.: US 2026/0158547 A1
(43) Pub. Date: Jun. 11, 2026

(54) METAL POWDER COMPOSITE FOR ADDITIVE MANUFACTURING AND METHOD FOR MANUFACTURING THE SAME

(71) Applicant: University-Industry Cooperation Group of Kyung Hee University, Yongin-si (KR)

(72) Inventors: Bin Lee, Seoul (KR); Uk Joo Kim, Bucheon-si (KR); Se Hun Kim, Seoul (KR); Tae Hoo Kang, Gwangyang-si (KR); Jong Ik Lee, Suwon-si (KR)

(73) Assignee: University-Industry Cooperation Group of Kyung Hee University, Yongin-si (KR)

(21) Appl. No.: 19/177,796

(22) Filed: Apr. 14, 2025

(30) Foreign Application Priority Data
Apr. 12, 2024 (KR) 10-2024-0049525

(51) Int. Cl. B22F 1/16; B22F 1/145; B22F 9/04; B33Y 70/00

(52) U.S. Cl. CPC B22F 1/16; B22F 1/145; B22F 9/04; B33Y 70/00; B22F 2301/205; B22F 2302/256; B22F 2998/10

(57) ABSTRACT

A metal powder composite for additive manufacturing includes non-spherical metal powder and hydrophobic nanoparticles surface-treated on the non-spherical metal powder. By surface-treating hydrophobic nanoparticles on non-spherical metal powder, which typically exhibits low flowability and is difficult to use in additive manufacturing, flowability is improved, thereby enabling the metal powder composite to be applied to additive manufacturing.

### CROSS-REFERENCE TO RELATED APPLICATION

This application claims the benefit under 35 U.S.C. § 119 (a) of Korean Patent Application No. 10-2024-0049525, filed on Apr. 12, 2024, the entire disclosure of which is incorporated herein by reference for all purposes.

### BACKGROUND

### 1. Field

The present disclosure relates to a metal powder composite for additive manufacturing and a method for manufacturing the same, and more particularly, to a metal powder composite for additive manufacturing in which hydrophobic nanoparticles are surface-treated on non-spherical metal powder particles having low flowability, thereby improving flowability, and to a method for manufacturing the same.

### 2. Description of Related Art

Three-dimensional (3D) printing technology, which produces objects by generating two-dimensional cross-sectional data based on three-dimensional shape data and laminating material accordingly, has rapidly advanced and is experiencing growing demand across various industries. While 3D printers were initially used primarily for limited applications such as prototyping in corporate settings, their utilization has recently expanded to a wide range of industries, including aerospace, healthcare, automotive, machinery, architecture, toys, and fashion. As the 3D printing technology and industry continue to grow, the market for 3D printing materials is also expected to expand.

Among various 3D printing materials, titanium powder (Ti powder) has recently attracted considerable attention due to its multifunctional structural properties and its use in high value-added industries. Titanium possesses excellent specific strength, corrosion resistance, low thermal deformation, and biocompatibility, making it a highly valuable industrial material well-suited for integration with 3D printers.

Metal powders used in additive manufacturing must exhibit excellent flowability to ensure uniform layering. Insufficient flowability may lead to agglomeration of the metal powders during processing, which in turn reduces the efficiency of additive manufacturing. From a material handling standpoint as well, it is advantageous for metal powders to exhibit a certain level of flowability.

Conventional titanium powders for additive manufacturing are typically spherical in shape to ensure flowability and are produced via a gas atomizing process. However, gas atomizing requires expensive gas atomizer equipment and consumables, resulting in a high cost of approximately USD 400 per kilogram for titanium powder produced by this method. Accordingly, there is a need to develop cost-effective methods for producing titanium powders that are applicable to additive manufacturing.

The Hydrogenation-Dehydrogenation (HDH) method produces titanium powder by utilizing the hydrogen absorption properties of titanium, and is economically favorable as it yields powder at approximately one-tenth the cost of gas-atomized titanium powder. However, HDH titanium powder typically has angular particle shapes and significantly lower flowability, rendering it unsuitable for use in additive manufacturing. Therefore, a technique is required to improve the flowability of such powders to make them suitable for additive manufacturing.

The inventors of the present invention have developed a metal powder composite for additive manufacturing, in which hydrophobic nanoparticles are surface-treated on non-spherical metal powders-characterized by low flowability-through methods such as mixing and ball milling. This treatment not only enhances the flowability of the powder but also improves the mechanical properties of the final additively manufactured product, thereby completing the present invention.

### SUMMARY

The present disclosure is intended to address problems encountered in the prior art by providing a metal powder composite capable of being used in additive manufacturing. In particular, the present disclosure aims to improve the flowability of non-spherical metal powder, which typically exhibits low flowability and is difficult to apply to additive manufacturing, by surface-treating hydrophobic nanoparticles on the surface of the non-spherical metal powder, thereby enabling the metal powder composite to be used in additive manufacturing.

Another object of the invention is to provide a method for manufacturing a metal powder composite applicable to additive manufacturing and the like, not only using non-spherical metal powders but also using metal powders whose flowability has deteriorated or which have undergone agglomeration due to reuse or external contamination.

In one general aspect, a metal powder composite for additive manufacturing includes: non-spherical metal powder; and hydrophobic nanoparticles surface-treated on the non-spherical metal powder.

The non-spherical metal powder may be selected from a group consisting of non-spherical Ti, Mg, Al, Sc, V, Cr, Mn, Fe, Co, Ni, Zn, Y, Zr, Nb, Mo, Ph, Pd, Ag, Cd, Hf, Ta, W, Re, Os, Ir, Pt, Au, and alloys thereof.

The hydrophobic nanoparticles may include one or more particles selected from a group consisting of SiO₂, Y₂O₃, Al₂O₃, TiO₂, ZrO₂, LizO, K₂O, Na₂O, In₂O₃, Ta₂O₅, Nb₂O₅, CaZrO₃, SiC, HfC, WC, ZrN, HfO₂, and Si₃N₄.

The hydrophobic nanoparticles may be in an amount in range of 0.05 wt % to 5.00 wt %, based on 100 wt % of the non-spherical metal powder.

In another general aspect, a method for manufacturing a metal powder composite for additive manufacturing includes: preparing non-spherical metal powder; and surface-treating hydrophobic nanoparticles on the non-spherical metal powder.

The step of preparing the non-spherical metal powder may include pulverizing the non-spherical metal powder.

The step of preparing the non-spherical metal powder may include removing moisture from the non-spherical metal powder.

The step of surface-treating hydrophobic nanoparticles on the non-spherical metal powder may include mixing the non-spherical metal powder with the hydrophobic nanoparticles.

The step of surface-treating hydrophobic nanoparticles on the non-spherical metal powder may include milling the non-spherical metal powder with the hydrophobic nanoparticles.

The hydrophobic nanoparticles may be in an amount in range of 0.05 wt % to 5.00 wt %, based on 100 wt % of the non-spherical metal powder.

The above-described means for solving the problems are merely exemplary and should not be construed as limiting the present disclosure. In addition to the exemplary embodiments described above, additional embodiments may be provided based on the drawings and the detailed description of the present disclosure.

The disclosed technology may offer the following advantages. However, it should be understood that a particular embodiment is not required to include all of the following advantages, nor should it be interpreted as being limited to these advantages alone. Accordingly, the scope of the disclosed technology should not be construed as being limited by the following description.

According to the present disclosure, it is possible to provide a metal powder composite suitable for additive manufacturing by improving the flowability of non-spherical metal powders—which typically exhibit low flowability and are therefore difficult to apply to additive manufacturing—through surface treatment with hydrophobic nanoparticles.

In addition, the present disclosure provides the advantage of enabling the use of not only non-spherical metal powders but also metal powders whose flowability has deteriorated or which have agglomerated due to reuse or external contamination, in additive manufacturing applications. Furthermore, the metal powder composite for additive manufacturing according to the present disclosure may enhance the mechanical properties of final additively manufactured products by incorporating a dispersion strengthening effect.

### BRIEF DESCRIPTION OF THE DRAWINGS

FIG. 1 is a schematic diagram schematically illustrating a metal powder composite for additive manufacturing according to an example of the present disclosure.

FIG. 2 is a flowchart illustrating a method for manufacturing a metal powder composite for additive manufacturing according to an example of the present disclosure.

FIG. 3 is a photograph of a final additively manufactured product produced using the metal powder composite for additive manufacturing according to an example of the present disclosure.

### DETAILED DESCRIPTION

It should be understood that the present disclosure is capable of various modifications and may have a variety of embodiments, and specific embodiments are illustrated in the drawings and described in detail in the specification. However, this is not intended to limit the present disclosure to any particular form, and it is to be understood that all modifications, equivalents, and substitutes that fall within the spirit and scope of the present disclosure are included.

In describing the drawings, similar reference numerals are used to designate similar components. The terms such as “first” and “second” may be used to describe various elements, but such elements are not limited by these terms. These terms are used only to distinguish one element from another.

For example, without departing from the scope of the present disclosure, a first element may be referred to as a second element, and similarly, a second element may be referred to as a first element.

The term “and/or” includes any and all combinations of one or more of the associated listed items.

Unless otherwise defined, all terms used herein, including technical and scientific terms, have the same meaning as commonly understood by one of ordinary skill in the art to which this disclosure belongs. Terms generally defined in commonly used dictionaries should be interpreted in accordance with their meaning in the context of the relevant art and the present disclosure and should not be interpreted in an overly idealized or overly formal sense unless expressly defined otherwise herein.

Throughout the present specification, when a component is referred to as “comprising” a particular element, unless expressly stated otherwise, this does not preclude the inclusion of other elements.

The terms of degree, such as “about” and “substantially,” as used herein, are intended to mean that deviations from exact numerical values are allowable, as recognized by one of ordinary skill in the art, to account for acceptable tolerances in manufacturing and materials, and to prevent unscrupulous infringers from unfairly taking advantage of the disclosure where precise or absolute numerical values are mentioned.

Furthermore, throughout the present specification, the phrase “step of ˜” does not imply a “step for ˜” unless expressly stated otherwise.

Throughout the present specification, the phrase “combinations thereof,” as included in Markush-type expressions, is intended to mean one or more mixtures or combinations selected from the group of elements recited in the Markush expression, and is intended to encompass one or more elements selected from the group.

The present specification discloses a metal powder composite for additive manufacturing, including: non-spherical metal powder; and hydrophobic nanoparticles surface-treated on the non-spherical metal powder.

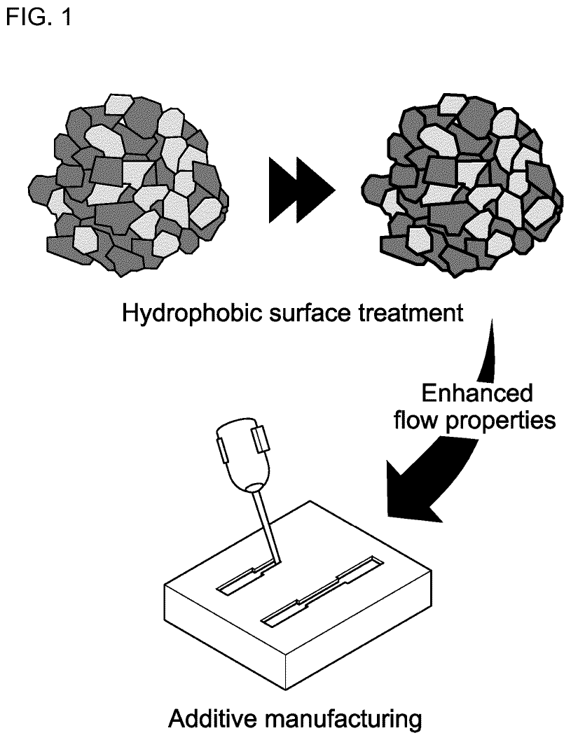

FIG. 1 is a schematic diagram illustrating a metal powder composite for additive manufacturing according to an example of the present disclosure. Referring to FIG. 1, it can be seen that the metal powder composite according to an example of the present disclosure includes non-spherical metal powder and hydrophobic nanoparticles that are surface-treated on the non-spherical metal powder. The metal powder composite according to an example of the present disclosure exhibits significantly improved flowability compared to non-spherical metal powder alone, and thus can be used in additive manufacturing such as 3D printing.

The metal powder composite for additive manufacturing according to an example of the present disclosure provides improved flowability and spreadability due to the surface treatment of the hydrophobic nanoparticles.

In particular, a technical feature of the metal powder composite for additive manufacturing according to the present disclosure lies in the use of non-spherical metal powder having low flowability, or metal powder whose flowability has deteriorated or which has undergone agglomeration due to reuse or external contamination. That is, the present disclosure can provide a metal powder composite suitable for additive manufacturing by modifying such metal powders that are otherwise difficult to apply in additive manufacturing processes.

Preferably, the non-spherical metal powder of the present disclosure has a particle diameter in the range of 1 to 150 μm, but is not limited thereto.

The non-spherical metal powder of the present disclosure is preferably selected from the group consisting of non-spherical Ti, Mg, Al, Sc, V, Cr, Mn, Fe, Co, Ni, Zn, Y, Zr, Nb, Mo, Ph, Pd, Ag, Cd, Hf, Ta, W, Re, Os, Ir, Pt, Au, and alloys thereof, but is not limited thereto.

In particular, the non-spherical metal powder of the present disclosure is preferably HDH (hydride-dehydride) titanium powder, obtained through hydrogenation and dehydrogenation, but is not limited thereto. The HDH titanium powder may naturally form titanium dioxide (TiO₂) on its surface through a reaction with oxygen in the atmosphere. The titanium dioxide present on the surface of the HDH titanium powder may react with moisture in the air to form hydroxyl groups (—OH) on the powder surface, which, due to their hydrophilic nature, leads to a reduction in flowability.

The reduction in flowability of metal powder may be attributed to factors such as friction between metal powder surfaces, interlocking caused by the geometric shape of the metal powder, electrostatic attraction between metal powders, and the formation of tackiness due to moisture absorption by the metal powder.

The metal powder composite for additive manufacturing according to the present disclosure is capable of blocking moisture adsorption by surface-treating hydrophobic nanoparticles on metal powder with reduced flowability, thereby preventing a decline in the flow characteristics of the metal powder in advance.

In addition, the hydrophobic nanoparticles of the present disclosure may also contribute to improvements in properties such as the strength and hardness of the final additively manufactured product produced using the metal powder composite for additive manufacturing.

The hydrophobic nanoparticles of the present disclosure are preferably selected from the group consisting of SiO₂, Y₂O₃, Al₂O₃, TiO₂, ZrO₂, Li₂O, K₂O, Na₂O, In₂O₃, Ta₂O₅, Nb₂O₅, CaZrO₃, SiC, HfC, WC, ZrN, HfO₂, and Si₃N₄, but are not limited thereto.

In particular, it is more preferable that the hydrophobic nanoparticles of the present disclosure be silicon oxide (SiO₂), but are not limited thereto.

The hydrophobic nanoparticles of the present disclosure are preferably present in an amount ranging from 0.05 wt % to 5.00 wt %, based on 100 wt % of the non-spherical metal powder, and more preferably in an amount ranging from 0.10 wt % to 0.50 wt %, based on 100 wt % of the non-spherical metal powder.

For example, when the hydrophobic nanoparticles of the present disclosure are surface-treated in an amount of less than 0.05 wt % based on 100 wt % of the non-spherical metal powder, the hydrophobic nanoparticles may not be sufficiently applied to the surface of the non-spherical metal powder, resulting in a problem in which the flowability remains low due to tack formation caused by moisture absorption. Conversely, when the hydrophobic nanoparticles of the present disclosure are surface-treated in an amount exceeding 5.00 wt % based on 100 wt % of the non-spherical metal powder, an excessive amount of hydrophobic nanoparticles may be applied to the surface of the non-spherical metal powder, which may increase friction or electrostatic attraction between the metal powder surfaces and thereby cause a reduction in flowability.

The metal powder composite for additive manufacturing according to the present disclosure can be applied to a powder bed fusion (PBF) process during additive manufacturing, and is applicable at a common additive manufacturing speed, such as a recoating speed of 10 mm/s or higher.

In addition, in order to achieve the above-described technical objectives, the present disclosure further provides a method for manufacturing a metal powder composite for additive manufacturing, the method comprising: preparing non-spherical metal powder; and surface-treating hydrophobic nanoparticles on the non-spherical metal powder.

In the method for manufacturing a metal powder composite for additive manufacturing according to the present disclosure, the details regarding the metal powder composite for additive manufacturing shall apply as described above with respect to the metal powder composite of the present disclosure.

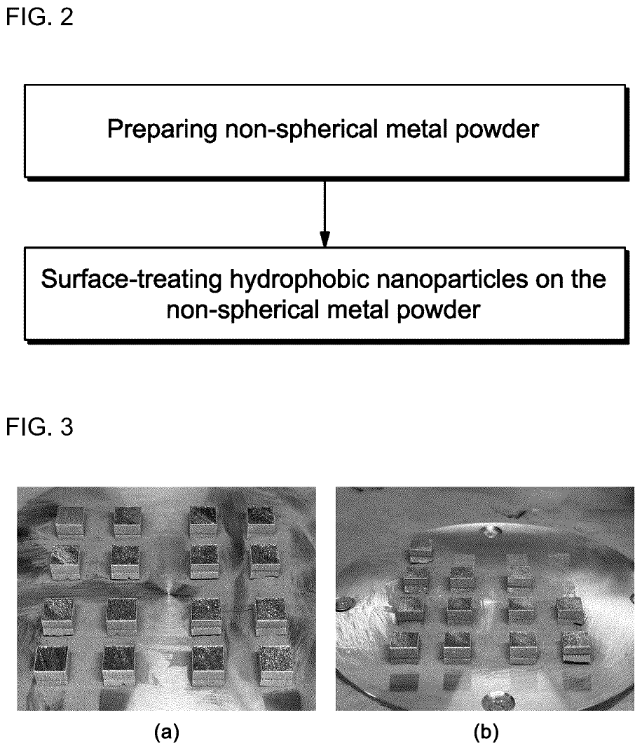

FIG. 2 is a flowchart illustrating a method for manufacturing a metal powder composite for additive manufacturing according to an example of the present disclosure. Referring to FIG. 2, it can be seen that the method for manufacturing a metal powder composite for additive manufacturing according to an example of the present disclosure includes: preparing non-spherical metal powder; and surface-treating hydrophobic nanoparticles on the non-spherical metal powder.

The manufacturing method of the present disclosure includes preparing non-spherical metal powder. Preparing the non-spherical metal powder may include pulverizing the non-spherical metal powder. In addition, preparing the non-spherical metal powder may include removing moisture from the non-spherical metal powder.

The pulverizing the non-spherical metal powder is preferably performed by placing the non-spherical metal powder and balls into a ball mill container and performing ball milling, but is not limited thereto.

The removing moisture from the non-spherical metal powder is preferably performed by drying the non-spherical metal powder through heat treatment, but is not limited thereto.

The manufacturing method of the present disclosure includes surface-treating hydrophobic nanoparticles on the non-spherical metal powder. This step may include mixing the non-spherical metal powder with the hydrophobic nanoparticles. It may further include milling the non-spherical metal powder with the hydrophobic nanoparticles.

Mixing the non-spherical metal powder with the hydrophobic nanoparticles is preferably performed by mixing the dried non-spherical metal powder and the hydrophobic nanoparticles, but is not limited thereto.

Milling the non-spherical metal powder with the hydrophobic nanoparticles is preferably performed by placing the dried non-spherical metal powder and the hydrophobic nanoparticles into a milling container and conducting milling, but is not limited thereto. During milling, balls may or may not be added, as long as effective mixing of the non-spherical metal powder and the hydrophobic nanoparticles can be achieved.

Ball milling refers to a process in which the target particles and grinding balls are loaded into a drum, and the drum is rotated to crush the particles through impact by the falling balls. During ball milling, the surfaces of the particles become activated due to the applied energy. Ball milling may apply energy to the surface of the non-spherical metal powder to activate it, enabling subsequent reaction with hydrophobic nanoparticles. Ball milling provides advantages in that it can round the shape of the non-spherical metal powder to improve flowability and allow rapid surface modification using hydrophobic nanoparticles by activating the non-spherical powder surface.

The mixing and/or milling for surface-treating hydrophobic nanoparticles on the non-spherical metal powder of the present disclosure can be carried out using equipment such as a tumbler ball mill, a tubular mixer, an attrition mill, or a planetary ball mill, but is not limited thereto.

The milling is preferably performed at a speed of 100 to 500 rpm for 1 to 5 hours, but is not limited thereto. When milling is performed outside these conditions, the surface treatment on the non-spherical metal powder may be insufficient or excessive, leading to deterioration in flowability.

The hydrophobic nanoparticles of the present disclosure are preferably present in an amount ranging from 0.05 wt % to 5.00 wt %, based on 100 wt % of the non-spherical metal powder, and more preferably in an amount ranging from 0.10 wt % to 0.50 wt %, based on 100 wt % of the non-spherical metal powder.

For example, when the hydrophobic nanoparticles of the present disclosure are surface-treated in an amount of less than 0.05 wt % based on 100 wt % of the non-spherical metal powder, the hydrophobic nanoparticles may not be sufficiently applied to the surface of the non-spherical metal powder, resulting in a problem in which the flowability remains low due to tack formation caused by moisture absorption. Conversely, when the hydrophobic nanoparticles are surface-treated in an amount exceeding 5.00 wt % based on 100 wt % of the non-spherical metal powder, an excessive amount of hydrophobic nanoparticles may be applied to the surface of the non-spherical metal powder, which may increase friction or electrostatic attraction between the metal powder surfaces and thereby cause a reduction in flowability.

The manufacturing method of the present disclosure may further include performing heat treatment to remove moisture from the metal powder composite for additive manufacturing, after surface-treating the non-spherical metal powder with hydrophobic nanoparticles. Although moisture is already removed during the surface treatment by mixing and ball-milling the dried non-spherical metal powder and the hydrophobic nanoparticles, additional heat treatment may optionally be performed to further remove any residual moisture.

Hereinafter, the present disclosure will be described in more detail with reference to the accompanying drawings and examples. However, the drawings and examples presented herein can be modified in various ways by those skilled in the art, and the technical scope of the present disclosure should not be limited to the specific embodiments disclosed herein but should include all equivalents and substitutes encompassed by the spirit and scope of the present disclosure. In addition, the accompanying drawings may be exaggerated or reduced for clarity and illustrative purposes.

### EXAMPLES AND EVALUATION

### Example: Preparation of Metal Powder Composite for Additive Manufacturing According to the Present Disclosure

After individually drying 50 g of HDH titanium powder having a particle diameter of 1 to 150 μm and silicon oxide (SiO₂), each material was loaded into a milling container, and milling was performed at 100 to 500 rpm for 1 to 5 hours to prepare a metal powder composite for additive manufacturing according to an example of the present disclosure. During the milling process, no separate milling balls were added, and the HDH titanium powder and silicon oxide were simply mixed.

At this time, the composition was classified as shown in Table 1 below according to the amount of silicon oxide added relative to 100 wt % of the HDH titanium powder.

TABLE 1

| Comparative | Comparative | | | |
|---|---|---|---|---|
| Example 1 | Example 2 | Example 1 | Example 2 | Example 3 |
| HDH titanium | HDH titanium | HDH titanium | HDH titanium | HDH titanium |
| powder | powder + silicon | powder + silicon | powder + silicon | powder + silicon |
| | oxide 0.01 wt % | oxide 0.05 wt % | oxide 0.10 wt % | oxide 0.50 wt % |

| | | Comparative | Comparative | |
|---|---|---|---|---|
| Example 4 | Example 5 | Example 3 | Example 4 | — |
| HDH titanium | HDH titanium | HDH titanium | Spherical | — |
| powder + silicon | powder + silicon | powder + silicon | titanium | |
| oxide 1.00 wt % | oxide 5.00 wt % | oxide 10.00 wt % | powder | |

### Evaluation 1. Measurement and Analysis of Flowability of Metal Powder and Metal Powder Composite

Table 2 below shows the flowability test results of the metal powder or metal powder composites according to the examples and comparative examples of the present disclosure.

TABLE 2

| | | | | Tap Density | |
|---|---|---|---|---|---|
| | Hall Flow | Hall Flow | Apparent | (g/ml) | |
| | (standard) | (carney) | Density | (time: 600 s, | Hausner |
| | (s/50 g) | (s/50 g) | (g/ml) | RPM: 300) | Ratio |
| Comparative | No Flow | No Flow | 1.35 | 1.98 | 1.47 |
| Example 1 | | | | | |
| Comparative | No Flow | No Flow | 1.44 | 1.99 | 1.38 |
| Example 2 | | | | | |
| Example 1 | 98.46 ± | 19.67 ± | 1.60 | 2.07 | 1.29 |
| | 5.97 | 4.60 | | | |
| Example 2 | 91.22 ± | 17.12 ± | 1.69 | 2.13 | 1.26 |
| | 6.48 | 2.9 | | | |
| Example 3 | No Flow | 20.77 ± | 1.70 | 2.10 | 1.24 |
| | | 6.04 | | | |
| Example 4 | No Flow | No Flow | 1.55 | 2.02 | 1.30 |
| Example 5 | No Flow | No Flow | 1.04 | 1.36 | 1.31 |
| Comparative | No Flow | No Flow | 1.23 | 1.74 | 1.41 |
| Example 3 | | | | | |
| Comparative | 28.90 ± | 6.82 ± | 2.56 | 3.28 | 1.28 |
| Example 4 | 0.58 | 0.1 | | | |

Hall Flow (standard) is an indicator of the flowability of powder, measured by allowing 50 g of powder to fall through a standard funnel with a 2.5 mm diameter orifice and recording the time required for the entire amount to pass through by gravity. Hall Flow (Carney) is measured in the same manner as Hall Flow (standard), except that it uses a funnel with a 5.0 mm diameter orifice. Hausner Ratio is an index of powder flowability, defined as the ratio of tap density to apparent density (Tap Density/Apparent Density). The tap density is determined by subjecting the powder to approximately 3,000 taps at 300 taps/min, then dividing the initial mass by the tapped volume. The apparent density is measured by allowing the powder to fall into a density cup solely under gravity through a funnel and then weighing the filled powder. The Hausner Ratio is generally greater than 1. As the flowability of the powder increases, the apparent density increases, resulting in a smaller difference between the tap density and the apparent density, and the measured value approaches 1.

Referring to Table 2, it can be seen that when the amount of silicon oxide added is 0.05 to 5.00 wt % relative to 100 wt % of HDH titanium powder, the flowability is superior compared to HDH titanium powder alone (Comparative Example 1). Also, it can be seen that flowability deteriorates when the amount of silicon oxide is 0.01 wt % or 10.00 wt %. In particular, it was found that when the amount of silicon oxide added is 0.10 wt % relative to 100 wt % of the HDH titanium powder, the flowability is the most improved.

Table 3 below shows the results of measuring the recoating density of the metal powder or the metal powder composite for additive manufacturing according to one embodiment and one comparative example of the present disclosure.

TABLE 3

| | Comparative | Comparative | | | |
|---|---|---|---|---|---|
| | Example 1 | Example 2 | Example 1 | Example 2 | Example 3 |
| Powder mass(g)/ | 9.57/1.22 | 9.63/1.32 | 12.97/1.49 | 10.81/1.38 | 6.52/0.83 |
| Recoating | | | | | |
| density(g/cm³) | | | | | |

| | | | Comparative | Comparative | |
|---|---|---|---|---|---|
| | Example 4 | Example 5 | Example 3 | Example 4 | — |
| Powder mass(g)/ | 8.05/1.03 | 3.70/0.47 | 2.19/0.33 | 16.80/2.38 | — |
| Recoating | | | | | |
| density(g/cm³) | | | | | |

The recoating tester simulates the PBF process by repeatedly lowering the build plate and performing recoating a predetermined number of times, and directly quantifies the recoating density of the resulting layered powder. The build plate is lowered by a programmed amount, and a recoater performs back-and-forth motion to spread the powder. The final recoated powder is weighed to determine recoating density.

Specifically, the recoater moves in one direction to build up a powder layer, after which the build plate is lowered by a preset amount, and this cycle is repeated. The recoating density can be measured according to various parameters such as the material and shape of the recoating blade, the recoating speed, and the lowering amount of the powder bed. Since the recoating tester replicates the PBF process except for the laser processing, it allows for quantitative evaluation of the recoating density achievable in an actual PBF process. It also provides a criterion for determining whether the powder under evaluation is suitable for the PBF process. In addition, it can be confirmed that higher recoating density of the powder layered on the powder bed through repeated recoating indicates superior recoating performance.

Referring to Table 3 above, it can be seen that when the amount of silicon oxide added is 0.05 to 5.00 wt % relative to 100 wt % of the HDH titanium powder, the recoating density is superior compared to that of the HDH titanium powder alone (Comparative Example 1). In particular, it was found that when the amount of silicon oxide added is 0.10 wt % relative to 100 wt % of the HDH titanium powder, the recoating density is the most improved.

### Evaluation 2. Results and Analysis of Additive Manufacturing Process Using Metal Powder and Metal Powder Composite

FIG. 3 is a photograph of a final additively manufactured product produced using the metal powder composite for additive manufacturing according to an example of the present disclosure. Specifically, (a) of FIG. 3 shows the result of producing the final additively manufactured product using the metal powder composite for additive manufacturing of Example 2 of the present disclosure, and (b) of FIG. 3 shows the result of producing the final additively manufactured product using the HDH titanium powder of Comparative Example 1 of the present disclosure.

Referring to FIG. 3, when the additive manufacturing process is performed using the HDH titanium powder of Comparative Example 1 of the present disclosure, it can be seen that, due to the low flowability of the HDH titanium powder, the melting between layers is insufficient, resulting in the formation of a non-uniform additively manufactured sample. In contrast, when the additive manufacturing process is performed using the metal powder composite for additive manufacturing of Example 2 of the present disclosure, it can be seen that the high flowability of the metal powder composite enables the formation of a uniform additively manufactured sample as intended.

According to the present disclosure, a metal powder composite that is applicable to additive manufacturing can be provided by improving the flowability of non-spherical metal powder, which typically exhibits low flowability and is difficult to use in additive manufacturing, through surface treatment with hydrophobic nanoparticles.

In addition, according to the present disclosure, not only non-spherical metal powder but also metal powder whose flowability has deteriorated or that has undergone agglomeration due to reuse or external contamination can be used to provide a metal powder composite applicable to additive manufacturing. Furthermore, by applying a dispersion strengthening effect, the metal powder composite for additive manufacturing according to the present disclosure can enhance the mechanical properties of a final additively manufactured article.

The foregoing description of the present disclosure is provided for purposes of illustration, and those skilled in the art to which the present disclosure pertains will understand that various modifications and variations can be made without departing from the spirit or essential characteristics of the present disclosure. Therefore, the embodiments described above are intended to be illustrative in all respects and not limiting. For example, elements that are described as being implemented in a singular form may be implemented in a distributed manner, and likewise, elements described as being distributed may be implemented in a combined form.

The scope of the present disclosure is defined by the following claims rather than by the foregoing detailed description, and all modifications and equivalents that fall within the meaning and scope of the claims and their equivalents should be construed as being included within the scope of the present disclosure.

What is claimed is:

1. A metal powder composite for additive manufacturing, comprising:
non-spherical metal powder; and
hydrophobic nanoparticles surface-treated on the non-spherical metal powder.

2. The metal powder composite for additive manufacturing of claim 1,
wherein the non-spherical metal powder is selected from a group consisting of non-spherical Ti, Mg, Al, Sc, V, Cr, Mn, Fe, Co, Ni, Zn, Y, Zr, Nb, Mo, Ph, Pd, Ag, Cd, Hf, Ta, W, Re, Os, Ir, Pt, Au, and alloys thereof.

3. The metal powder composite for additive manufacturing of claim 1,
wherein the hydrophobic nanoparticles comprise one or more particles selected from a group consisting of SiO₂, Y₂O₃, Al₂O₃, TiO₂, ZrO₂, Li₂O, K₂O, Na₂O, In₂O₃, Ta₂O₅, Nb₂O₅, CaZrO₃, SiC, HfC, WC, ZrN, HfO₂, and Si₃N₄.

4. The metal powder composite for additive manufacturing of claim 1,
wherein the hydrophobic nanoparticles are in an amount in range of 0.05 wt % to 5.00 wt %, based on 100 wt % of the non-spherical metal powder.

5. A method for manufacturing a metal powder composite for additive manufacturing, comprising:
preparing non-spherical metal powder; and
surface-treating hydrophobic nanoparticles on the non-spherical metal powder.

6. The method for manufacturing a metal powder composite for additive manufacturing of claim 5,
wherein the preparation of the non-spherical metal powder comprises pulverizing the non-spherical metal powder.

7. The method for manufacturing a metal powder composite for additive manufacturing of claim 5,
wherein the preparation of the non-spherical metal powder comprises removing moisture from the non-spherical metal powder.

8. The method of manufacturing a metal powder composite for additive manufacturing of claim 5,
wherein the surface treatment of hydrophobic nanoparticles on the non-spherical metal powder comprises mixing the non-spherical metal powder with the hydrophobic nanoparticles.

9. The method of manufacturing a metal powder composite for additive manufacturing of claim 5,
wherein the surface treatment of hydrophobic nanoparticles on the non-spherical metal powder comprises milling the non-spherical metal powder with the hydrophobic nanoparticles.

10. The method of manufacturing a metal powder composite for additive manufacturing of claim 5,
wherein the hydrophobic nanoparticles are in an amount in range of 0.05 wt % to 5.00 wt %, based on 100 wt % of the non-spherical metal powder.
